(19) United States
(12) Patent Application Publication
(10) Pub. No.: US 2005/0116035 A1
(43) Pub. Date: Jun. 2, 2005

(54) Card reader

(75) Inventor: Udo Winkelmann, Rochester, MI (US)

Correspondence Address: BIRCH STEWART KOLASCH & BIRCH, PO BOX 747, FALLS CHURCH, VA, 22040-0747, US

(73) Assignee: Preh-Werke GmbH & Co. KG, Bad Neustadt a. d. Saale (DE)

(21) Appl. No.: 10/954,213

(22) Filed: Oct. 1, 2004

Related U.S. Application Data
(60) Provisional application No. 60/507,526, filed on Oct. 2, 2003.

(51) Int. Cl. G06K 7/00; G06K 7/06; G06K 7/08

(52) U.S. Cl. 235/439; 235/441; 235/449

(57) ABSTRACT

A dust or dirt-sweeping brush is provided in a swiping slot and/or insertion slot of a card reader. Preferably, the brush is mounted on an interior housing wall of the card reader so that the bristles of the brush cover the swiping slot and/or the insertion slot. The bristles of the brush can thereby be fixed into place on a self-adhesive band, which is affixed at least in the area of the swiping slot and/or the insertion slot of the card reader, thereby protecting a reader head that is located below. It is also possible to caulk the brush from the inside or to fix it into place during the injection molding process. The bristles are very fine fibers that yield to pressure so that the swiping and/or insertion of the card does not negatively influence the functioning of the card reader.

This nonprovisional application claims priority to U.S. Provisional Application 60/507,526, which was filed on Oct. 2, 2003, and which is herein incorporated by reference.

### BACKGROUND OF THE INVENTION

1. Field of the Invention

The present invention relates to a card reader, particularly for a keyboard, such as a Point-of-Sale (POS) keyboard.

2. Description of the Background Art

Keyboards, for example, POS keyboards, include, among other things, a magnetic card reader and/or a Smart-Card Reader, that is, a hybrid reader, in which a card having a magnetic strip is swiped through a slot in the surface of the card reader and/or a chip card is inserted into an opening. Such a keyboard is known from DE 100 34 346 C2. These devices have the disadvantage that dirt deposits etc. can accumulate inside the opening, that is, in the slot in the surface of the card reader, and can dirty the reader head itself, which frequently causes the reader head to malfunction.

EP 0 702 315 B1 (DE 695 24 701 T2) describes a dust-proof portable IC card reader that has a guide channel, that is, an IC card insert port for an IC card to be inserted, and an card accommodating unit extending straight from the IC card insert port to the opposite side thereof. The IC card insert port has a lid member, which is pushed to the inside when the card is inserted in order to clean the inside of the IC card accommodating unit.

From DE 36 10 202 C2, a handset with a card reading device is known, whereby the handset has a collapsible wall element, which has a spring-loaded press-on element for pressing the card onto a contact surface. At the insertion slot for the card, a safeguard is arranged, at least an elastic sealing rim or bristles. A sweeping device for cleaning the card is provided around the sides of the insertion slot.

### SUMMARY OF THE INVENTION

It is therefore an object of the present invention to provide a protection for a card reader, particularly a POS keyboard, through which at least dirt and dust would be prevented from penetrating the card reader.

The invention is based on the idea to integrate a dust or dirt-sweeping brush in the swiping and/or insertion slot of the card reader. Preferably, the brush is arranged in the inner wall of the card reader housing so that the bristles of the brush cover the swiping/insertion slot. The bristles of the brush can thereby be fixed on a self-adhesive band, which is then affixed at least in the area of the swiping/insertion slots of the card reader, thereby protecting the reader head below. As an alternative, it is possible to caulk the brush in the housing of the card reader in the area of the reader head from the inside, or to fix it into place during the injection molding process. The bristles are made of very fine, flexible fibers so that the swiping/insertion of the card does not negatively influence the functioning of the card reader.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1: illustrates a keyboard with a card reader and a brush in the swiping slot, according to a preferred embodiment of the present invention;

FIG. 2: illustrates the enlarged card reader of FIG. 1; and

FIG. 3: is a cross-section A-A of the card reader of FIG. 2.

### DETAILED DESCRIPTION

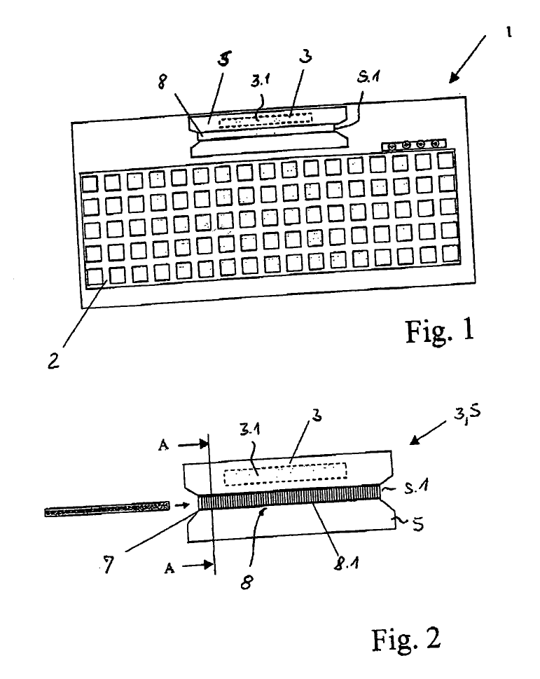

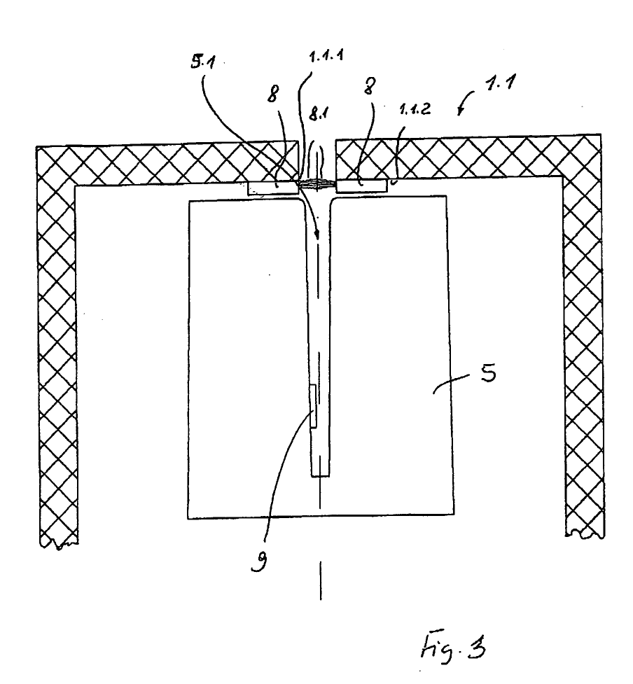

FIG. 1 illustrates a keyboard 1 having at least one key pad 2 as well as a card reader 3, 5 that in this figure is integrated into a keyboard housing 1.1. In this embodiment, the card reader 3 can be a chip card reader, into which a card (not shown in detail) can be inserted vertically into insertion slot 3.1. An additional card reader 5, for example, a magnetic card reader, has a swiping slot 5.1 for a magnetic card 7 (FIG. 2). A separate card reader 3, 5 with a card reader housing of its own (not shown in detail) is also feasible.

At least in the area of the swiping slot 5.1, the integration of a fine brush 8 with bristles 8.1 is provided in order to keep dust and dirt from the card reader 3, 5, but especially from the reader head 9.

As can be seen in FIG. 3, the brush 8 is attached, either on one side or on both sides, in the housing interior 1.1.2 in the area of the swiping slot 5.1 above the card reader 5 with reader head 9. This can be done with an adhesive bond, by fixing into place during the injection molding, that is, during the manufacturing process of the housing of the card reader 3, 5 and/or the keyboard housing 1.1, or by caulking. Thereby, the brush(es) is/are flush at least with the swiping edge 1.1.1 pointing to the card reader 5 in the housing 1.1.

In a variation of the adhesion process, the brush(es) 8 is/are glued from below against the interior wall of the housing 1.1.2. The soft bristles 8.1 either directly touch the opposite edge of the housing 1.1.1 or, if two brushes 8 are used, lightly touch the opposite bristles 8.1.

When cold or warm caulking is applied, pegs (not shown in detail), preferably pointing to the inside, are provided on the housing interior 1.1.2 of the housing 1.1, which engage with at least one hole in the brush 8, thus fixing the brush 8 into place.

Attaching and affixing the brush(es) 8 during the injection molding process of the card reader housing or the keyboard housing 1.1 can also be done through fixing in the tool. In this case, care must be taken to keep the bonding agent from getting onto the brush extensions 8.1.

The idea can also be applied to the card reader 3. In this case, the brush 8 can be provided by adhesion, caulking or fixing into place during the injection molding process, either on one or on both sides of the insertion slot 3.1 of the IC card reader 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A card reader includes a reader head, which is located in a swiping slot or insertion slot in a housing of the keyboard or the card reader, wherein in an interior housing wall of the housing, at least in an open area of the swiping slot or the insertion slot, at least one brush with bristles is arranged.

2. The card reader according to claim 1, wherein the brush is attached by adhesion.

3. The card reader according to claim 1, wherein the brush is attached by caulking.

4. The card reader according to claim 1, wherein the brush is fixed in an injection tool and is molded over during manufacturing of the housing.

5. The card reader according to claim 1, wherein the bristles are soft fibers.

6. A keyboard comprising:
a plurality of keys; and
a card reader having a reader head and an insertion slot, the insertion slot being formed so that the reader head is able to read a card that is inserted into the insertion slot,
wherein a brush having a plurality of bristles is fixedly adhered to at least one side of the insertion slot so that a substantial portion of the bristles of the brush contact the card upon insertion into the insertion slot.
